(19) United States
(12) Patent Application Publication
(10) Pub. No.: US 2008/0259298 A1
(43) Pub. Date: Oct. 23, 2008

(54) Lithographic apparatus and device manufacturing method

(75) Inventors: Vadim Yevgenyevich Banine, Helmond (NL); Arno Jan Bleeker, Westerhoven (NL); Johannes Hubertus Josephina Moors, Helmond (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 11/785,745

(22) Filed: Apr. 19, 2007

(51) Int. Cl. G03B 27/42

(52) U.S. Cl. 355/53; 355/67

(57) ABSTRACT

A lithographic apparatus for maskless EUV applications includes an illumination system constructed and arranged to condition a radiation beam and to supply the conditioned radiation beam to a spatial light modulator, a substrate table constructed and arranged to hold a substrate, and a projection system constructed and arranged to project the conditioned radiation beam onto a target portion of the substrate. The illumination system includes a field facet mirror constructed and arranged to define a field of the conditioned radiation beam. The field facet mirror is constructed and arranged to optically match a source of radiation and the illumination system.

### FIELD

The present invention relates to a lithographic apparatus for maskless applications and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

A plurality of patterning devices are used to fabricate a device on the substrate. These patterning devices, also referred to as reticles, are becoming increasingly costly and time consuming to manufacture due to the feature sizes and the exacting tolerances specified for small feature sizes. Also, a patterning device can typically only be used for a certain period of time before being worn out. Further costs are routinely incurred if a reticle is damaged. In order to overcome these difficulties, maskless lithography systems have been developed. The maskless system replaces a reticle with a spatial light modulator (SLM), notably a digital micromirror device (DMD), a liquid crystal display (LCD) or the like. The SLM includes an array of active areas (e.g. mirrors or transmissive areas) that can be modulated to form a desired pattern. A predetermined and previously stored algorithm based on a desired exposure pattern is used to modulate the active areas. Preferably, the SLM is arranged to enable suitable exposure all desired area on a substrate for each pattern during only one pass of the substrate.

Extreme Ultra-Violet (EUV) maskless lithography constitutes a new technology development. However, an illuminator system known for conventional (EUV) lithographic apparatuses cannot be directly transferred for maskless EUV applications, because EUV maskless has a much lower etendue than the conventional EUV system and even significantly lower etendue than the current EUV source of radiation. This may result in substantial energy losses and, consequently, reduced wafer throughput.

### SUMMARY

It is desirable to provide a lithographic apparatus for EUV maskless applications where energy losses during optical coupling between the source of radiation and the illumination system are mitigated.

According to an aspect of the invention, a lithographic apparatus for maskless EUV applications is provided. The apparatus includes an illumination system constructed and arranged to condition a radiation beam and to supply the conditioned radiation beam to a spatial light modulator, a substrate table constructed and arranged to hold a substrate, and a projection system constructed and arranged to project the conditioned radiation beam onto a target portion of the substrate. The illumination system includes a field facet mirror constructed and arranged to define a field of the conditioned radiation beam. The field facet mirror is constructed and arranged to optically match a source of radiation and the illumination system.

According to an aspect of the invention, a lithographic projection apparatus for EUV maskless applications arranged to project a beam of radiation onto a substrate is provided. The apparatus includes an illumination system constructed and arranged to condition a radiation beam and to supply the conditioned radiation beam to a spatial light modulator. The illumination system includes a field facet mirror constructed and arranged to define a field of the conditioned radiation beam. The field facet mirror is constructed and arranged to optically match a source of radiation and the illumination system.

According to an aspect of the invention a device manufacturing method for maskless EUV lithographic applications is provided. The method includes conditioning a radiation beam emanating from a source of radiation with an illumination system, defining a field of the conditioned radiation beam with a field facet mirror of the illumination system, optically matching the source of radiation and the illumination system with the field facet mirror, supplying the conditioned radiation beam to a spatial light modulator, and projecting a patterned beam of radiation with a projection system onto a target portion of a substrate.

According to an aspect of the invention, a device manufacturing method for maskless EUV lithographic applications is provided. The method includes conditioning a radiation beam emanating from a source of radiation with an illumination system, defining a field of the conditioned radiation beam with a field facet mirror of the illumination system, optically matching the source of radiation and the illumination system, patterning the conditioned radiation beam with a spatial light modulator, and projecting the patterned radiation beam onto a target portion of a substrate.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts an embodiment of a lithographic apparatus suitable for maskless EUV applications according to the prior art;

FIG. 2 depicts a further embodiment of a lithographic apparatus suitable for maskless EUV applications according to the prior art;

FIG. 3 depicts in a schematic way an embodiment of an illumination systems of the known lithographic apparatus suitable for EUV applications with a mask;

FIG. 4 depicts in a schematic way an embodiment of a lithographic apparatus for maskless EUV applications according to the invention;

FIG. 5 depicts in a schematic way a further embodiment of a lithographic apparatus for maskless EUV applications according to the invention;

FIG. 6 depicts in a schematic way a further embodiment of a lithographic apparatus for maskless EUV applications according to the invention;

FIG. 7 depicts in a schematic way an embodiment of a filter suitable for maskless EUV applications; and

FIG. 8 schematically depicts a cross-section of part of the filter 400 shown in FIG. 7.

### DETAILED DESCRIPTION

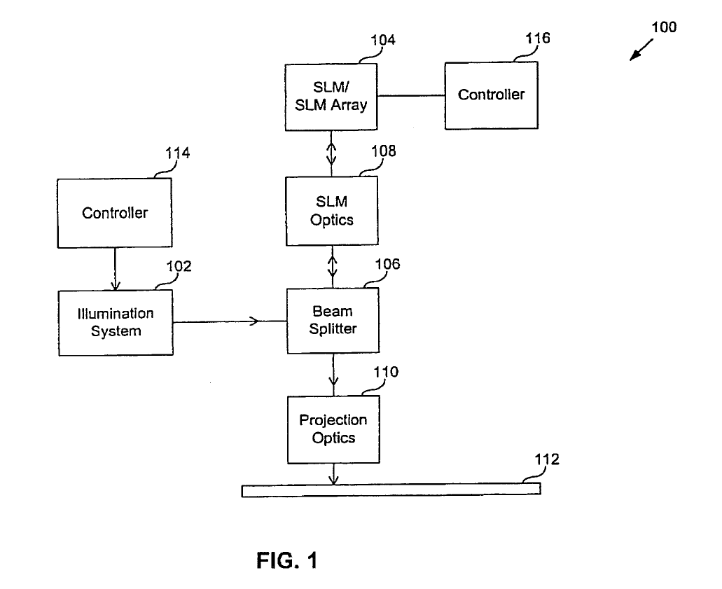

FIG. 1 shows a maskless lithography system 100 in accordance with the prior art. System 100 includes an illumination system 102 that transmits light to a reflective spatial light modulator 104 (e.g., a digital micromirror device (DMD), a reflective liquid crystal display (LCD), or the like) via a beam splitter 106 and SLM optics 108. SLM 104 is used to pattern the light in place of a reticle in traditional lithography systems. Patterned light reflected from SLM 104 is passed through beam splitter 106 and projection optics 110 and written on an object 112 (e.g. a substrate, a semiconductor wafer, a glass substrate for a flat panel display, or the like).

The illumination optics may be housed within illumination system 102, as is known in the relevant art. SLM optics 108 and projection optics 110 may include any combination of optical elements needed to direct light onto desired areas of SLM 104 and/or object 112, as is known in the relevant art. One or both of illumination system 102 and SLM 104 may be coupled to or have integral controllers 114 and 116, respectively. Controller 114 may be used to adjust illumination source 102 based on feedback from system 100 or to perform calibration. Controller 116 may also be used for adjustment and/or calibration. Alternatively, controller 116 may also be used for modulating active devices (e.g. pixels, mirrors, locations, etc., (not shown)) on SLM 104, as was described above, to generate a pattern used to expose object 112. Controller 116 may either have integral storage or be coupled to a storage element (not shown) with predetermined information and/or algorithms used to generate the pattern or patterns.

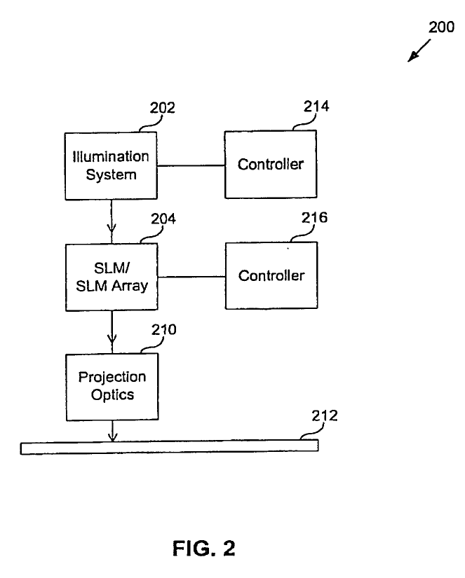

FIG. 2 shows a maskless lithography system 200 according to a further embodiment of the prior art. System 200 includes an illumination source 202 that transmits light through a SLM 204 (e.g. a transmissive LCD, or the like) to pattern the light. The patterned light is transmitted through projection optics 210 to write the pattern on a surface of an object 212. In this embodiment, SLM 204 is a transmissive SLM, such as a liquid crystal display, or the like. Similar to above, either one or both of illumination source 202 and SLM 204 can be coupled to or integral with controllers 214 and 216, respectively. Controllers 214 and 216 can perform similar functions as controllers 114 and 116 described above.

Embodiments of suitable SLM's are described in application EP 1 482 336 A2 of the same Applicant, which is hereby incorporated by reference.

EUV radiation sources, such as discharge plasma radiation sources, may use a relatively high partial pressure of a gas or vapor to emit EUV radiation. In a discharge plasma source, for example, a discharge is created in between electrodes, and a resulting partially ionized plasma may subsequently be caused to collapse to yield a very hot plasma that emits radiation in the EUV range. The very hot plasma Xe is a gas that can be used to form the plasma, since a Xe plasma radiates in the extreme UV (EUV) range around 13.5 mm. For an efficient EUV production, a typical pressure of 0.1 mbar is used near the electrodes of the radiation source. A possible drawback of having such a high Xe pressure is that Xe gas absorbs EUV radiation. For example, 0.1 mbar Xe transmits over 1 m only 0.3% EUV radiation having a wavelength of 13.5 mm. It is therefore desirable to confine the high Xe pressure to a limited region around the source. To achieve this, the source can be contained in its own vacuum chamber in which the collector mirror and illumination optics may or may not also be contained.

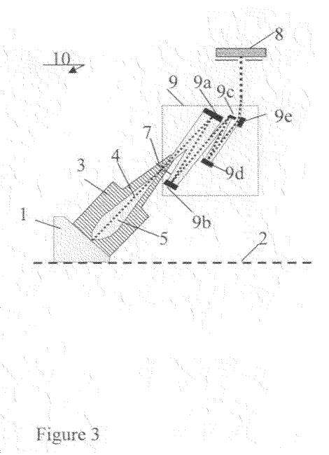

FIG. 3 depicts in a schematic way an embodiment of an illumination system of a known lithographic apparatus 10 suitable for EUV applications with a mask. As illustrated, the lithographic apparatus 10 comprises a source 1 of the radiation, notably EUV radiation. The EUV radiation emanating from the source 1 usually is characterized by an etendue of about 0.5-6 mm² sr. For convenience, a level lab floor 2 is schematically shown. The light bundle 5 is collected by a suitable collector 3 and is focused to a slit 7. The light bundle 5 is shown with an optical axis 4 to ease understanding. The conventional EUV lithographic apparatus further comprises an illuminator system 9 configured to condition a radiation beam emanating from the source of radiation 1 and to supply the conditioned radiation beam to a mask 8. The light on its path to the mask undergoes a plurality of reflections at respective mirrors. The sequence of mirrors applicable for the EUV lithography comprises an Field facet (FF) mirror 9a, pupil facet (PF) mirror 9b, N1 mirror 9c, N2 mirror 9d and G mirror 9e. Therefore, the light bundle undergoes at least 7 reflections at respective mirrors before exiting illuminator system 9 and impinging on a suitable mask 8. It is noted that at each mirror about 30% of the light bundle is lost.

The known setup of the illuminator module 9 is found to be not directly applicable for maskless EUV technology, notably because etendue of a suitable EUV source typically lies in the range of 0.008 mm² sr. Therefore, if the known illuminator system is to be used in the EUV maskless technology, substantial losses of energy may occur, thereby resulting in a substantially decreased wafer throughput.

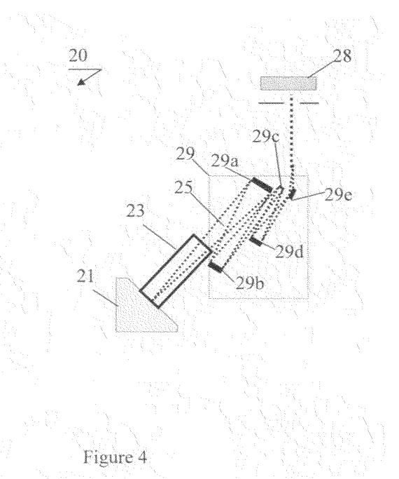

FIG. 4 depicts in a schematic way an embodiment of a lithographic apparatus 20 for maskless EUV applications according to the invention. In accordance with the an embodiment, the lithographic apparatus 20 for maskless EUV applications is provided in which an increased transmission is obtained. The apparatus 20 comprises an EUV source 21 producing a beam 25 of radiation. A new illuminator system 29 is provided in which no conventional collector is used. In fact, the field facet (FF) mirror 29a functions as the collector due to the fact that the EUV source is characterized by a substantial smaller etendue than a conventional system. Accordingly, due to a small opening angle of the beam 25, typically diverging at an angle between about 0.1 sr and about 0.5 sr, the FF mirror 29a can be placed at substantially increased distances with respect to the EUV source 21. As a result of the increased distance between the source 21 and the FF mirror 29a having a function of a collector, a suitable debris mitigation system 23 may be positioned between the source 21 and the illuminator system 29. Due to small angle divergence of the source 21, the debris mitigation system 23 may be more transparent and may include magnetic field and other high mitigation suppressors, which are typically difficult to arrange in the optical system due to a large angle of the source and short allowable mitigation distance. The illuminator system 29 supplies the conditioned beam of radiation to a spatial light modulator 28.

Additionally, due to the small angle of the source 21 and absence of shadowing spider wheels and other suitable supports used in the known apparatus, the field uniformity may be much higher. As a result, the FF functionality may become easier. Also, due to large etendue filling (high field density), the facetted filling of the pupil facet (PF) mirror 29b may not be needed. Furthermore, due to small angle, the pupil uniformity as well as pupil functionality may improve.

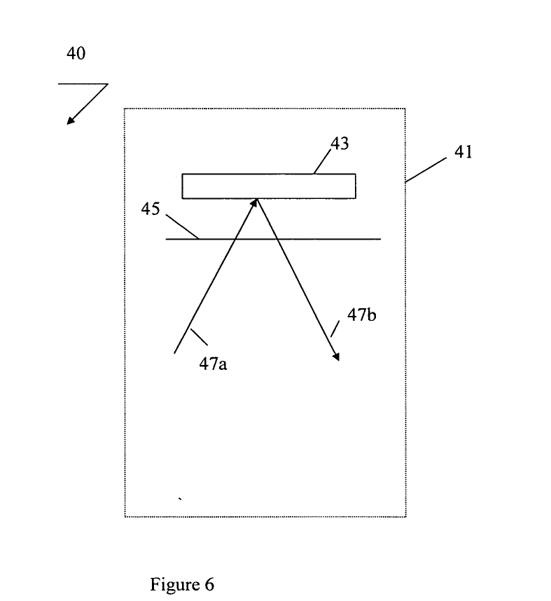

Preferably, the apparatus further comprises a filter comprising a multi-layered structure of alternating layers. The filter may also be configured to enhance the spectral purity of a radiation beam by reflecting or absorbing undesired radiation, the filter also being configured to collect debris emitted from a radiation source. This particular embodiment of the apparatus will be discussed in further detail below with reference to FIG. 6.

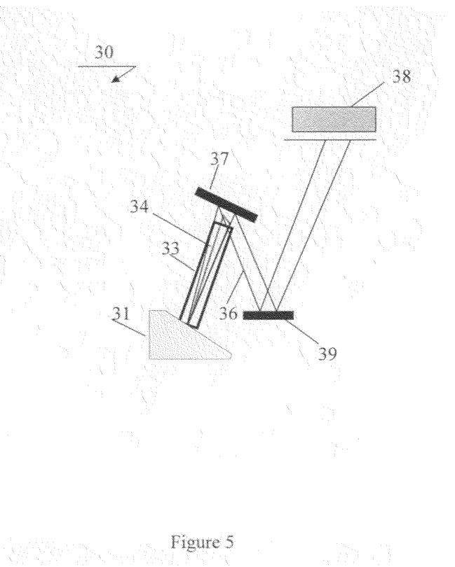

FIG. 5 depicts in a schematic way an embodiment of a lithographic apparatus for maskless EUV applications in which folding and shaping mirrors (items 29c, 29d, 29e in FIG. 3) are removed from the illuminator system. Accordingly, the apparatus 30 comprises an EUV source 31 and an illuminator system with solely an FF mirror 37 having a function of the collector and a PF mirror 39 for delivering the light beam to the spatial light modulator 38. The apparatus 30 may further comprise a suitable decoupler 34 of the spatial movement of the source 31, notably an aperture, for example with an effective size of 50 micrometer at the source. By cutting the radiation field by means of the aperture parasitic spatial movement of the source may be mitigated.

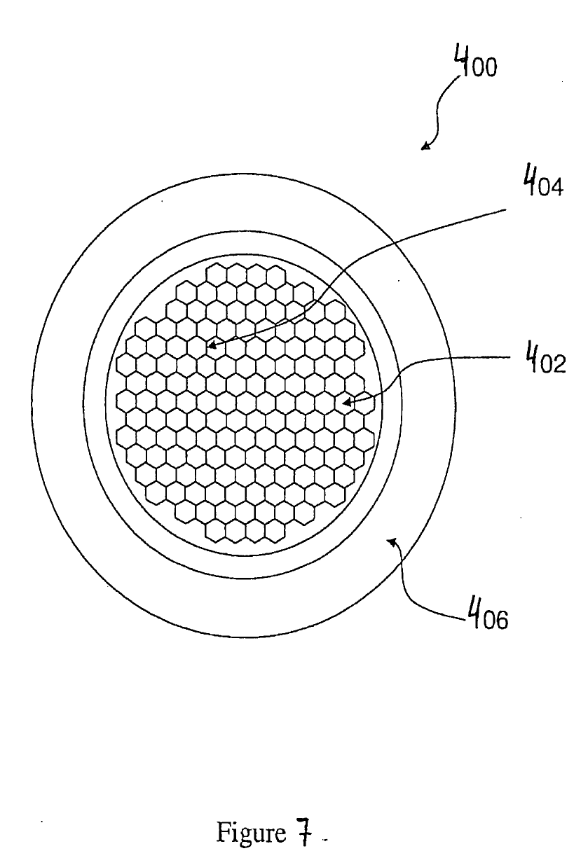

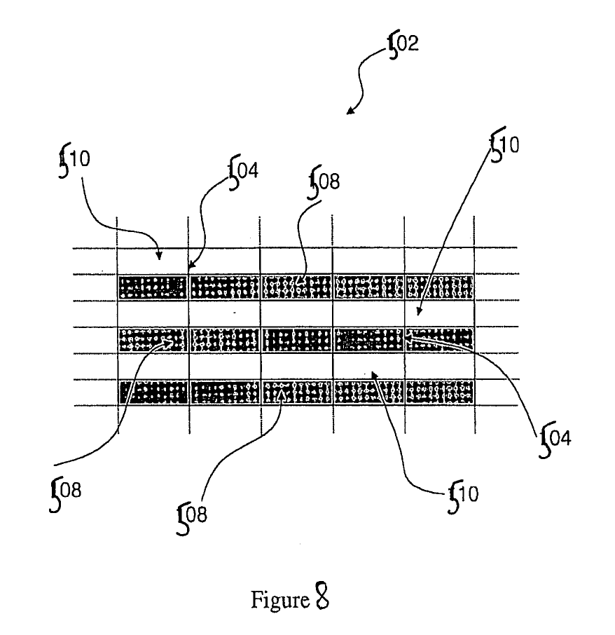

FIG. 6 depicts in a schematic way an embodiment of a lithographic apparatus 40 for maskless EUV applications. In general, no suitable filter exists for maskless EUV lithographic applications. In the present embodiment, a portion 41 of an lithographic apparatus, notably suitable for EUV maskless applications, is shown. A filter 45 is arranged at an off-axis position between a source (not shown) and a spatial light modulator 43, and comprises a multi-layered structure of alternating layers. The filter 45 is configured to enhance the spectral purity of a radiation beam by reflecting or absorbing undesired radiation, and is also configured to collect debris emitted from a radiation source. The filter is described in more detail with reference to FIGS. 7 and 8. In maskless EUV technology, no high accelerations should be applied at the level of a suitable multilayer array. The particle contamination of the spatial light modulator (SLM) 43 may be mitigated by installing a spectral purity membrane in front of the EUV SLM at an off-focus position. By installing the filter at the off-focus position and by choosing a multilayered Zr/Si spectral purity filter for the filter, a synergistic effect may occur, e.g., the EUV radiation beam may transverse such filter and the debris emanating from the source may be mitigated. Therefore, a suitable EUV filter may be provided. Other portions related to architecture of the lithographic apparatus may be suitably selected in accordance with any features of FIG. 1-FIG. 5.

FIG. 7 depicts in a schematic way an embodiment of a filter 400 suitable for maskless EUV applications. The filter 400 has a multi-layered structure formed by a plurality, for example 50, alternating Zr/Si layers 402. Alternative embodiments may have between about 2 and about 200 alternating Zr/Si layers 402. The filter 400 may also include a mesh 404. The mesh 404 may be made from Cu and may form a honeycomb structure including substantially hexagonal shaped apertures with a size of about 1 mm² to about 1.5 mm². The mesh 404 penetrates from one side to the other side of the alternating Zr/Si layers 402. In alternative embodiments, meshes 404 may be placed adjacent to one side only or on both sides of the Zr/Si layers 402, or may partially penetrate into the Zr/Si layers 402.

The mesh 404 enhances the integral strength of the Zr/Si layers 402. The Zr/Si layers 402 are mounted in a substantially annular shaped base 406. The shape of the annular shaped base 406 facilitates the incorporation of the filter 400 into a lithographic apparatus. The filter 400 may therefore be more easy to handle.

The Zr/Si layers 402 are designed to be substantially robust. For example, Zr/Si layers 402 are shown in FIG. 7 with a mesh and with a total thickness of about 200 nm and a surface area of about 1 cm² to about 10 cm² can withstand pressure differences up to about 0.5 bar to about 1 bar.

FIG. 8 schematically depicts a cross-section of part of the filter 400 shown in FIG. 7. In FIG. 8, the thickness of the Zr layers 508 is about 1 nm and the thickness of the Si layers 510 is about 3 nm. FIG. 8 shows the mesh 504 extending through the Zr/Si layers 502. In alternative embodiments, although not shown, the thickness of the Zr/Si layers 502 may be variable. Although not fully shown in FIG. 8, there may be 50 or more alternating layers of Zr and Si. Additionally, although not shown, the filter 400, 500 may be made in a modular form and may therefore form any required surface area. Using the filter 400, 500 as is described with reference to the foregoing, effective filtering of DUV is obtainable. The filter can thus act as a spectral purity filter, having only about 20% light loss with up to about 100×10⁵ gain in EUV to DUV ratio. In addition, the filters 400, 500 according to the present invention mitigate debris such as atomic particles, micro-particles and ions emitted produced from a suitable radiation source. The filter 400, 500 may have a total thickness of the multi-layered structure of alternating layers ranging from about 10 nm to about 700 nm. The alternating layers forming the multi-layered structure may be formed from a combination of any of the following: Zr and Si layers; Zr and B₄C layers; Mo and Si layers; Cr and Sc layers; Mo and C layers; and Nb and Si layers. The filters 400, 500 as are discussed with reference to the foregoing may be used as a pellicle for intercepting debris. Such pellicle may be placed at an off-focus position before the spatial light modulator. This arrangement may be advantageous due to the fact that the pellicle acts as a spectral purity filer enhancing the purity of the radiation beam and as a thin film collecting the debris. By placing the pellicle at the off-focus position, the debris collected on a surface of the pellicle is not imaged on a substrate.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A lithographic apparatus for maskless EUV applications, comprising (c)an illumination system constructed and arranged to condition a radiation beam and to supply the conditioned radiation beam to a spatial light modulator;
a substrate table constructed and arranged to hold a substrate; and
a projection system constructed and arranged to project the conditioned radiation beam onto a target portion of the substrate,
the illumination system comprising a field facet mirror constructed and arranged to define a field of the conditioned radiation beam, said field facet mirror being constructed and arranged to optically match a source of radiation and the illumination system.

2. A lithographic apparatus according to claim 1, further comprising the source of radiation, the source of radiation being constructed and arranged to provide the radiation beam to the illumination system.

3. A lithographic apparatus according to claim 2, wherein the source of radiation and the illumination system form a subsystem of the lithographic apparatus, the subsystem having an etendue smaller than about 1.0 mm²sr.

4. A lithographic apparatus according to claim 3, wherein the etendue is smaller than about 0.03 mm²sr.

5. A lithographic apparatus according to claim 4, wherein the etendue is between about 0.01 mm²sr and about 0.005 mm²sr.

6. A lithographic apparatus according to claim 2, wherein the radiation beam emanating from the radiation source has an angle of divergence between about 0.1 sr and about 0.5 sr.

7. A lithographic apparatus according to claim 2, further comprising a debris mitigation module arranged between the source of radiation and the field facet mirror.

8. A lithographic apparatus according to claim 2, wherein the apparatus further comprises an aperture arranged at the source of radiation, the aperture being constructed and arranged to decouple a spatial movement of the source.

9. A lithographic apparatus according to claim 1, wherein the illumination system further comprises a pupil facet mirror constructed and arranged to cooperate with the field facet mirror to directly supply the conditioned radiation beam to the spatial light modulator.

10. A lithographic apparatus according to claim 1, further comprising a filter comprising a multi-layered structure of alternating layers, wherein the filter is constructed and arranged to enhance the spectral purity of the radiation beam by reflecting or absorbing undesired radiation, and is configured to collect debris.

11. A lithographic apparatus according to claim 10, wherein the multi-layered structure of alternating layers has a mesh-like structure embedded therein.

12. A lithographic apparatus according to claim 1, wherein the radiation beam has an angle of divergence between about 0.1 sr and about 0.5 sr.

13. A lithographic projection apparatus for EUV maskless applications arranged to project a beam of radiation onto a substrate, the apparatus comprising: an illumination system constructed and arranged to condition a radiation beam and to supply the conditioned radiation beam to a spatial light modulator, the illumination system comprising a field facet mirror constructed and arranged to define a field of the conditioned radiation beam, said field facet mirror being constructed and arranged to optically match a source of radiation and the illumination system.

14. A lithographic apparatus according to claim 13, further comprising the source of radiation, the source of radiation being constructed and arranged to provide the radiation beam to the illumination system.

15. A lithographic apparatus according to claim 14, wherein the source of radiation and the illumination system form a subsystem of the lithographic apparatus, the subsystem having an etendue smaller than about 1.0 mm²sr.

16. A lithographic apparatus according to claim 15, wherein the etendue is smaller than about 0.03 mm²sr.

17. A lithographic apparatus according to claim 15, wherein the etendue is between about 0.01 mm²sr and about 0.005 mm²sr.

18. A lithographic apparatus according to claim 14, wherein the radiation beam emanating from the source of radiation has an angle of divergence between about 0.1 sr and about 0.5 sr.

19. A lithographic apparatus according to claim 14, further comprising a debris mitigation module arranged between the source of radiation and the field facet mirror.

20. A lithographic apparatus according to claim 14, further comprising an aperture arranged at the source of radiation, the aperture being constructed and arranged to decouple a spatial movement of the source of radiation.

21. A lithographic apparatus according to claim 13, wherein the illumination system further comprises a pupil facet mirror constructed and arranged to cooperate with the field fact mirror to directly supply the conditioned radiation beam to the spatial light modulator.

22. A lithographic apparatus according to claim 13, further comprising a filter comprising a multi-layered structure of alternating layers, wherein the filter is constructed and arranged to enhance the spectral purity of a radiation beam by reflecting or absorbing undesired radiation, and to collect debris.

23. A lithographic apparatus according to claim 22, wherein the multi-layered structure of alternating layers has a mesh-like structure embedded therein.

24. A lithographic apparatus according to claim 13, wherein the radiation beam which is to be conditioned by the illumination system has an angle of divergence between about 0.1 sr and about 0.5 sr.

25. A device manufacturing method for maskless EUV lithographic applications, the method comprising
conditioning a radiation beam emanating from a source of radiation with an illumination system;
defining a field of the conditioned radiation beam with a field facet mirror of the illumination system;
optically matching the source of radiation and the illumination system with the field facet mirror;
supplying the conditioned radiation beam to a spatial light modulator; and
projecting a patterned beam of radiation with a projection system onto a target portion of a substrate.

26. A method according to claim 25, mitigating debris between the source of radiation and the field facet mirror with a debris mitigation module.

27. A method according to claim 25, further comprising decoupling a spatial movement of the source of radiation with an aperture arranged at the source of radiation.

28. A method according to claim 25, further comprising directly supplying the conditioned radiation beam to the spatial light modulator with a pupil facet mirror cooperating with the field facet mirror.

29. A method according to claim 25, further comprising enhancing the spectral purity of the radiation beam by reflecting or absorbing undesired radiation, and collecting debris with a filter comprising a multi-layered structure of alternating layers.

30. A method according to claim 29, wherein the multi-layered structure of alternating layers has a mesh-like structure embedded therein.

31. A device manufacturing method for maskless EUV lithographic applications, the method comprising:
conditioning a radiation beam emanating from a source of radiation with an illumination system;
defining a field of the conditioned radiation beam with a field facet mirror of the illumination system;
optically matching the source of radiation and the illumination system;
patterning the conditioned radiation beam with a spatial light modulator; and
projecting the patterned radiation beam onto a target portion of a substrate.

32. A method according to claim 31, further comprising mitigating debris between the source of radiation and the field facet mirror with a debris mitigation module.

33. A method according to claim 31, further comprising decoupling a spatial movement of the source of radiation with an aperture arranged at the source.

34. A method according to claim 31, further comprising directly supplying the conditioned radiation beam to the spatial light modulator with a pupil facet mirror of the illumination system, the pupil facet mirror cooperating with the field facet mirror.

35. A method according to claim 31, further comprising enhancing the spectral purity of a radiation beam by reflecting or absorbing undesired radiation with a filter, and collecting debris with the filter, the filter comprising a multi-layered structure of alternating layers.

36. A method according to claim 35, wherein the multi-layered structure of alternating layers has a mesh-like structure embedded therein.
